(19) United States
(12) Patent Application Publication
(10) Pub. No.: US 2005/0179836 A1
(43) Pub. Date: Aug. 18, 2005

(54) Color developing structure and display device

(75) Inventors: Isao Shimoyama, Nerima-ku (JP); Kiyoshi Matsumoto, Nakano-ku (JP); Eiji Iwase, Chiyoda-ku (JP)

Correspondence Address: OLIFF & BERRIDGE, PLC, P.O. BOX 19928, ALEXANDRIA, VA, 22320, US

(73) Assignee: The University of Tokyo, Tokyo (JP)

(21) Appl. No.: 11/037,126

(22) Filed: Jan. 19, 2005

(30) Foreign Application Priority Data
Jan. 23, 2004 (JP) 2004-15,939

(51) Int. Cl. G02F 1/1335

(52) U.S. Cl. 349/106

(57) ABSTRACT

A color developing structure includes a substrate, at least one color developing object provided on the substrate, and control means for controlling the color development of the color developing object by a mechanical, electric or chemical action. The color developing object has a wavelength-selective reflection or transmission characteristic.

### TECHNICAL FIELD

The present invention relates to a color developing structure and a display used in paint, ink, a sensor measuring the physical quantity and so on, the color developing structure and the display having a variable wavelength-selective reflection or transmission characteristic and developing a variable structural color.

### BACKGROUND OF THE INVENTION

Such a color developing structure does not have its own color as itself differently from a pigment developing a color due to the electronic properties of its own molecule or solid itself, develops a color due to such action as reflection, interference, diffraction and so on of light depending on its structure, and has advantages of being less in aging caused by ultraviolet rays, being easy to become glossy and so on, and thus is expected to be used in painting a car, coloring fibers and so on.

As such a color developing structure, there have been proposed, for example, a structure with two kinds of materials alternately laminated on each other, the materials being different in refractive index from each other as described in JP, H07-34324, A (FIG. 1) and JP, 2000-246829, A (FIG. 1), for example, a structure provided with lamella as described in JP, H09-157957, A (FIG. 1), for example and a luminous body imitating a blue morpho butterfly being famous as a natural thing having a structural color as described in JP, 2003-053875, A (FIG. 1), for example.

Recently, a reflection type of a color display device is rapidly expanding uses thereof in a field of various devices such as a mobile device including a mobile telephone, a mobile game machine and so on. The reflection type of the color display device has an advantage of making it possible to reduce the power for a light source and save the space and weight of a backlight compared with a see-through type of a color display device since the reflection type of the color display device needs no backlight.

In case of the reflection type of the color display device, it is possible to reduce the power consumption as a whole and use a small battery. Thereby, the reflection type of the color display device has an advantage of not only being suitable for various devices desired to reduce in weight and thickness but also greatly increasing operating time thereof because of being capable of using a large-size battery in case of designing the color display device being the same in size and weight as a conventional color display device.

Such a reflection type of the color display device also exhibits an excellent characteristic from the viewpoint of contrast characteristics of a display surface. That is, in a CRT display device being a self-light emitting type of the display device, a transmission type of a color liquid crystal display device and so on, the contrast ratio is remarkably reduced in outdoors at daytime, on one hand, the reflection type of the color display device realizes an excellent contrast ratio because of obtaining display light proportional to the amount of surrounding light in principle and the reflection type of the color display device is expected to be used in the open air, on the other hand. However, an actual reflection type of the liquid crystal display device does not provide a sufficient performance.

The reflection type of the liquid crystal display widely used at present adopts a structure utilizing one or two polarizing plates and having color filter juxtaposed therein. Such a reflection type of the liquid crystal display device operates in the following modes:
1. A twisted nematic mode (TN mode) performing display by controlling the optical rotating power of a liquid crystal layer by an electric field.
2. A double refraction mode (ECB mode) performing display by controlling the double refraction of a liquid crystal layer by an electric field.
3. A mixed mode with a TN mode and an ECB mode combined together.

Because a conventional reflection type of the display device has the efficiency of utilizing light of a polarizing plate and color filter juxtaposed not less than 50%, it is insufficient in display quality, particularly in brightness. As a result, a sufficient reflectance cannot be attained and it is difficult to obtain a bright display of a desired level.

Until now, in order to enhance the reflectance, the reflection type of the display device of a method without the polarizing plate and the color filter has been examined. As a method without the polarizing plate, there is being developed a liquid crystal display device utilizing a guest-host type liquid crystal in which dyes is added to liquid crystal, a polymer dispersed type liquid crystal, a cholesteric liquid crystal and so on. On the other hand, as a method without the color filter juxtaposed, there is being developed a color display device having three display panels laminated on one another, the display panels being different in color from one another as described in JP, H10-260427, A (FIG. 1) for example.

### SUMMARY OF THE INVENTION

However, color developing structures described in JP, H07-34324, A, JP, 2000-246829, A and JP, H09-157957 have a disadvantage of changing color depending on a viewing angle. And a color developing structure described in JP, 2003-053875, A can provide a high reflectance as suppressing variation in color depending on the viewing angle but cannot perform a variable color development and, as a result, cannot realize a variable color display.

An object of the present invention is to provide a color developing structure and a display device capable of performing a variable color development without a disadvantage of changing the color depending on the viewing angle.

A color developing structure according to the present invention comprises;
a substrate,
at least one color developing object provided on the substrate, the color developing object having a wavelength-selective reflection or transmission characteristic, and
control means for controlling the color development of the color developing object by a mechanical, electric or chemical action.

A display device according to the present invention comprising;
a substrate,
a plurality of color developing objects provided on the substrate, each of the color developing object having a wavelength-selective reflection or transmission characteristic, and
control means for controlling the color development of the color developing objects by a mechanical, electric or chemical action,
wherein the color developing object are arranged in the form of an array.

According to the present invention, since the color development of at least one color developing object having a wavelength-selective reflection or transmission characteristic is controlled by a mechanical, electric or chemical action, it is possible to perform a variable color development without a disadvantage of varying in color according to a viewing angle.

### BRIEF DESCRIPTION OF THE DRAWINGS

FIG. 1 shows a first embodiment of a color developing structure according to the present invention.

FIG. 2 shows a second embodiment of a color developing structure according to the present invention.

FIG. 3 shows a third embodiment of a color developing structure according to the present invention.

FIG. 4 shows a fourth embodiment of a color developing structure according to the present invention.

FIG. 5 shows a fifth embodiment of a color developing structure according to the present invention.

FIG. 6 shows a first embodiment of a display device according to the present invention.

FIG. 7 shows a second embodiment of a display device according to the present invention.

FIG. 8 shows an embodiment using a color developing structure according to the present invention as paint.

### BEST MODE FOR CARRYING OUT THE INVENTION

Embodiments of a color developing structure and a display device according to the present invention are described in detail with reference to the drawings.

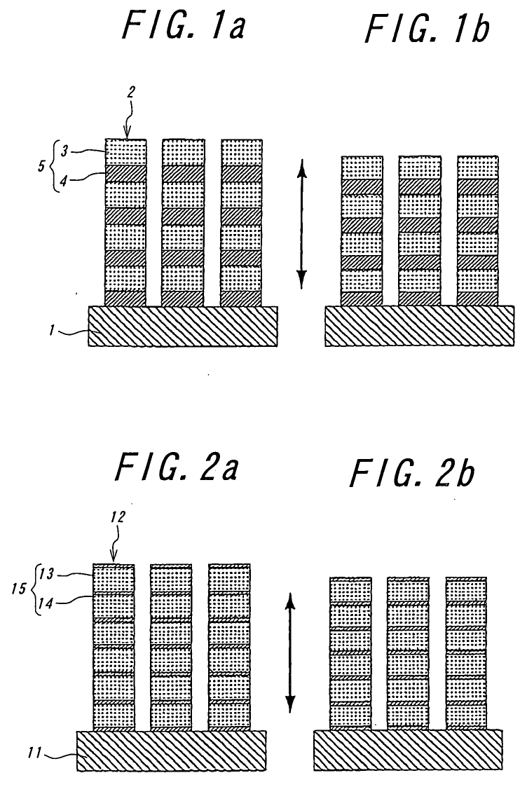

FIG. 1(a) shows a first embodiment of a color developing structure according to the present invention in inactive state, and FIG. 1(b) shows the first embodiment of a color developing structure according to the present invention in active state. This color developing structure comprises a substrate 1, a color developing object 2 provided on the substrate 1 and a controller not shown, and the color developing object 2 has a laminated object 5 composed of a low refractive index layer 3 with the refractive index n1 and the thickness t1 and a high refractive index layer 4 with the refractive index n2 (n2>n1) and the thickness t2. The controller not shown controls a selected wavelength or a color development by changing the spatial period of repetition of the color developing object 2. The thickness t1 and the thickness t2 in the active state are smaller in than those in the inactive state, respectively.

Preferably, the interval between the color developing objects is 10 to 300 nm from the viewpoint of obtaining a high efficiency of reflection due to a photonic band gap effect. Light with the selected wavelength λ satisfying the relation “m×λ=2(n1×t1+n2×t2)” with respect to the natural number m is selectively intensified and reflected.

In this embodiment, a repeating structure of the color developing object 2 is a structure repeating in distribution of refractive index. Provided that the distribution of refractive index in the direction of thickness of the color developing object 2 is n(z) and the spatial period of repetition is t, with respect to the natural number m, the light with the selected wavelength λ satisfying the following expression is selectively intensified and reflected.:
m×λ=2∫ₜ₀^{t0+1}n(z)dz [expression 1]
The natural number m is preferably 1 from the viewpoint of maximizing the efficiency of reflection and is preferably 2 or 3 from the viewpoint of easy manufacture.

FIG. 2(a) shows a second embodiment of a color developing structure according to the present invention in inactive state, and FIG. 2(b) shows the second embodiment of a color developing structure according to the present invention in active state. This color developing structure comprises a substrate 11, a color developing object 12 provided on the substrate 11 and a controller not shown, and the color developing object 12 has a laminated object 15 composed of a metal thin film 13 and a refractive layer with the refractive index n3 and the thickness t3. The thickness t3 in active state is smaller than the thickness in inactive state.

In this case, light with the selected wavelength λ satisfying the relation “m×λ=2(n3×t3)” with respect to the natural number m is selectively intensified and reflected. The wavelength λ is preferably changed in the range of 300 to 800 nm. Preferably, the thickness of the metal thin film 13 is not more than 50 nm from the viewpoint of the intensity of transmitted light, or the efficiency of reflection.

Preferably, the above-mentioned controller changes the electric field, the magnetic field, the mechanical vibration field, the pressure field, the thermal field or the optical field and generates the electric field by applying the voltage with electrodes, generates the magnetic field with a coil, generates the mechanical vibration field with a piezoelectric element, generates a pressure field with the air pressure or the water pressure, or generates the thermal field by electric current-heating with electrodes, for example. In case of generating the magnetic field with a permanent magnet or generating the optical field with laser irradiation, it is not necessary to dispose the controller in the vicinity of the color developing object 12 and it is possible to dispose the controller apart from the color developing object 12.

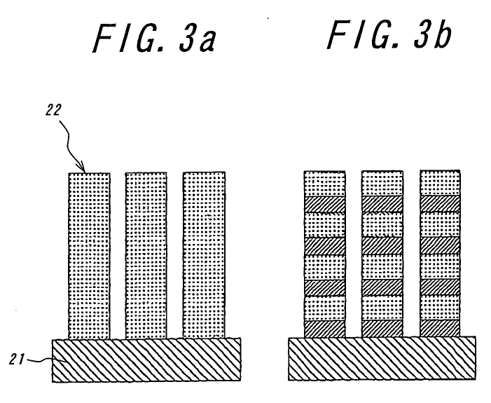

FIG. 3(a) shows a third embodiment of a color developing structure according to the present invention in inactive state, and FIG. 3(b) shows the third embodiment of a color developing structure according to the present invention in active state. This color developing structure comprises a substrate 21, a color developing object 22 provided on the substrate 21 and a controller not shown, and the color developing object 22 has a repeating structure as shown in FIG. 1 generated in active state or inactive state (active state in FIG. 3), and has no repeating structure generated at the other (inactive state in FIG. 3).

For example, in case of generating the distribution of refractive index by means of the mechanical vibration field, the distribution of refractive index, or a repeating structure is not generated when applying no mechanical vibration field. In this case, also, the selected wavelength λ can be controlled by the above-mentioned controller.

When controlling the selected wavelength, it is necessary to operate the controller at the time of a wavelength change but it is not necessary to operate the controller at the time of maintaining the selected wavelength. This realizes a low power consumption not necessary to provide energy from an external field at a static image displaying state with a bi-stable or multi-stable structure.

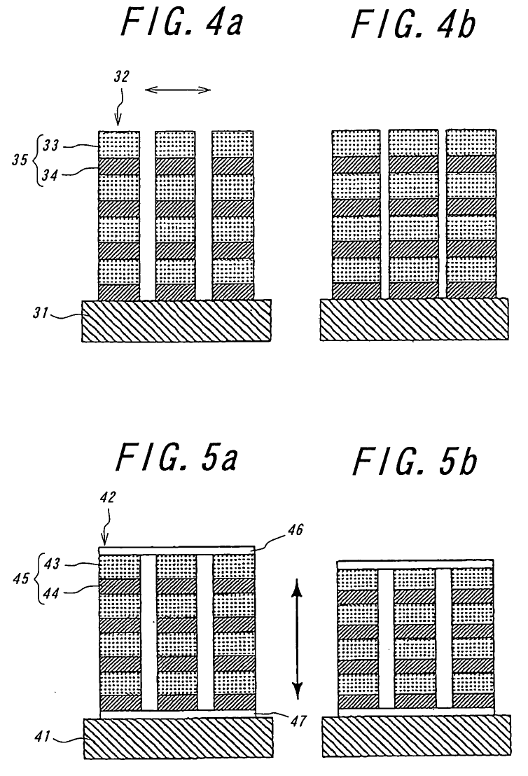

FIG. 4(a) shows a fourth embodiment of a color developing structure according to the present invention in inactive state, and FIG. 4(b) shows the fourth embodiment of a color developing structure according to the present invention in active state. This color developing structure comprises a substrate 31, a color developing object 32 provided on the substrate 31 and a controller not shown, and the color developing object 32 has a laminated object 35 composed of a low refractive index layer 33 with the refractive index n1 and the thickness t1 and a high refractive index layer 34 with the refractive index n2 (n2>n1) and the thickness t2. The controller not shown controls a selected wavelength, or a color development by changing the spatial period of structural repetition in the color developing object 2.

In this case, by the above-mentioned controller, the spatial period of two-dimensional arrangement of the color developing objects 32 changes, that is, the width of the color developing object 32 in active state is larger than the thickness thereof in inactive state. Thereby, the efficiency of reflection of the selected wavelength λ does not change, however, it is possible to change the efficiency of reflection of the other wavelengths and thus it is possible to change the color development.

FIG. 5(a) shows a fifth embodiment of a color developing structure according to the present invention in inactive state, and FIG. 5(b) shows the fifth embodiment of a color developing structure according to the present invention in active state. This color developing structure comprises a substrate 41, a color developing object 42 provided on the substrate 41 and a controller not shown. The color developing object 42 has a laminated object 45 composed of a low refractive index layer 43 with the refractive index n1 and the thickness t1 and a high refractive index layer 44 with the refractive index n2 (n2>n1) and the thickness t2, the laminated object 45 is interposed between electrodes 46 and 47. The controller not shown controls the selected wavelength, or a color development by changing the spatial period of structural repetition in the color developing object 42. The thickness t1 and the thickness t2 in active state are smaller than those in inactive state, respectively.

By interposing the color developing object 42 between the electrodes 46 and 47 as such, in an electrostatic drive type of a variable color developing structure, it is possible to reduce the influence on color development by making the substrate 41 and at least one of the electrodes 46 and 47 transparent.

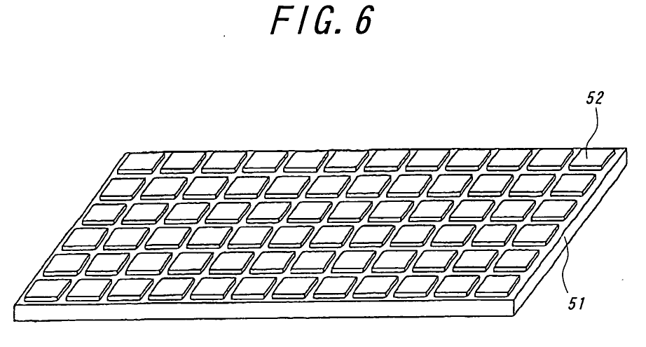

FIG. 6 shows a first embodiment of a display device according to the present invention. This display device comprises a rigid substrate 51, color developing objects 52 arranged in the form of an array on the substrate 51 and a controller not shown. The color developing object 52 has the same structure as that shown in one of FIGS. 1 to 5. In this embodiment, it is possible to display variable information including a reflection type of color static and dynamic images.

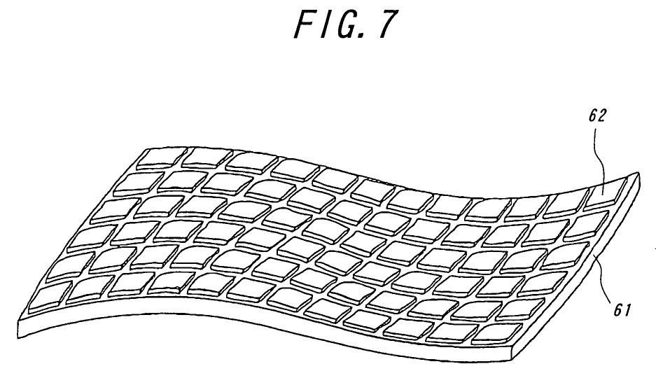

FIG. 7 shows a second embodiment of a display device according to the present invention. This display device comprises a flexible substrate 61, color developing objects 62 arranged in the form of an array on the substrate 61 and a controller not illustrated. The color developing object 62 has the same structure as that shown in one of FIGS. 1 to 5. In this embodiment, it is possible to display variable information including a reflection type of color static and dynamic images.

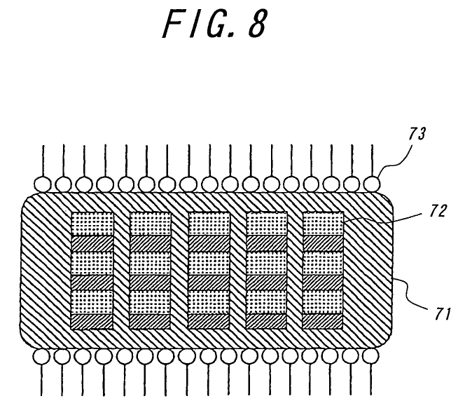

FIG. 8 shows an embodiment using a color developing structure according to the present invention as paint. In this embodiment, a color developing object 72 in the form of a chip is provided on a substrate 71 and a surface-treated layer 73 is chemically treated with a self-textured single-molecule film (SAMs) and so on.

Thereby, self-textured orientation is obtained in case that a solvent is dissolved and used as paint. As described above, by using a controller capable of being remotely placed, that is, controlling at a distant position, it is possible to perform a variable color development without an energy source to the above-mentioned chip. Therefore, in case of using such a color developing structure as paint for a car, it is possible to change the color of the car properly.

A summary of the present invention is as follows.

The present invention provides a color developing structure of a reflection type or a transmission type using a microstructure having a high brightness and being easily made into a thin film, the color developing structure being capable of displaying variable information containing color static and dynamic images, and a display device provided with the same. Discoloration does not occur in the color display using such a color developing structure.

A display device according to the present invention uses a color developing structure which has a plurality of laminated objects each having two or more layers different in refractive index from one another laminated on one another, the laminated objects being arranged two-dimensionally at intervals shorter than wavelength of visible light and controls the color development of them by changing the optical thicknesses and intervals of those layers by means of a mechanical, electric or chemical action. That is, the present invention provides a variable color developing display element of a reflection type or a transmission type with a plurality of color developing objects arranged two-dimensionally on a substrate and controlling the color development thereof by changing the optical thicknesses and intervals of those layers by means of a mechanical, electric or chemical action of a controller.

An example of such a variable color developing display element is of a transmitted light controlling type and has color developing objects arranged two-dimensionally at intervals not longer than wavelength of visible light on a substrate. An example of such a variable color developing display element has a controller (for generating a field) for generating at least one of an electric field, a magnetic field, a vibratory field, a pressure field, a thermal field and an optical field over, under, inside or outside (in case of remote powering) the color developing objects, or so as to have the color developing objects interposed between such fields.

An example of the color developing objects is of a structure with a relatively high refractive index layer and a relatively low refractive index layer laminated on each other at the time of either of in active state and in inactive state (cholesteric liquid crystal of an acoustic-optical element type). Another example of color developing objects is of a structure having a relatively high refractive index layer and a relatively low refractive index layer, which have different periodic structures from each other according to the action of a controller, laminated on each other (variable color development by application of voltage).

Another example of color developing objects is of a laminated structure of a relatively high refractive index layer and a relatively low refractive index layer, each of which has a periodic structure at the time of in inactive state of a controller, and is of a laminated structure of a relatively high refractive index layer and a relatively low refractive index layer, each of which has a periodic structure different from the above-mentioned period because of such action as application, removal and so on a specified voltage, and does not need action or energy of the controller in order to keep periodic structure (bi-stable/multi-stable) thereof.

A color developing object can be also formed from a low Young's modulus material such as palylene and so on mechanically deformed by an attractive electrostatic force between electrodes (electrostatic force), a material with a piezoelectric characteristic such as plumbum zirconate titanate (PZT) and so on mechanically deformed by applying a voltage between electrodes (piezoelectric), a material with a shape memory effect such as TiNi and so on mechanically deformed by electric current-heating between electrodes (shape memory alloy), a material such as Ni, Fe or an alloy thereof generating an attractive force by a magnetic field (magnetic field), or a piezo-optical material such as PZLT and so on mechanically deformed by an optical field. A substrate can be also formed from a flexible material such as polyimide (flexible substrate).

An example of such a display device is formed by arranging variable color developing elements in the form of an array (a reflective display). Another example of such a display device is provided with a backlight. And a variable color developing paint can be also formed by mixing variable color developing elements with a solvent. In this case it is preferable to make uniform the orientations of a plurality of variable color developing elements after painting, by varying the chemical properties of the self-textured single molecule film (SAMs) or the surface (automatic orientation). Further a physical quantity sensor for converting a mechanical, electric or chemical change into a color change can be also formed by using variable color developing elements.

The present invention is not limited to the above-described embodiments but can be modified and varied in various manners.

1. A color developing structure comprising;
a substrate,
at least one color developing object provided on said substrate, said color developing object having a wavelength-selective reflection or transmission characteristic, and
control means for controlling the color development of said color developing object by a mechanical, electric or chemical action.

2. A display device comprising;
a substrate,
a plurality of color developing objects provided on said substrate, each of said color developing object having a wavelength-selective reflection or transmission characteristic, and
control means for controlling the color development of said color developing objects by a mechanical, electric or chemical action,
wherein said color developing object are arranged in the form of an array.
